(19) United States
(12) Patent Application Publication
(10) Pub. No.: US 2009/0167496 A1
(43) Pub. Date: Jul. 2, 2009

(54) Radio frequency identification transponder memory

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, SUNNYVALE, CA (US)

(21) Appl. No.: 12/006,187

(22) Filed: Dec. 31, 2007

(51) Int. Cl. H04Q 5/22

(52) U.S. Cl. 340/10.1; 711/101

(57) ABSTRACT

A radio frequency identification (RFID) transponder includes a vertically configured non-volatile memory array. The RFID transponder additionally includes a logic circuitry connected with the vertically configured non-volatile memory array. The logic circuitry is configured to read data from the vertically configured non-volatile memory array. Additionally included is an antenna, which is connected with the logic circuitry. The antenna is configured to collect power from a radio frequency signal and to transmit the data. The non-volatile memory array may include a plurality of two-terminal memory cells that store data as a plurality of conductivity profiles that can be non-destructively sensed by applying a read voltage across the terminals of the cell. The logic circuitry can be positioned in a logic plane and at least one non-volatile memory array may be positioned on top of the logic plane and the non-volatile memory arrays may be vertically stacked upon one another.

### FIELD OF THE INVENTION

The present invention relates to semiconductors and, more particularly, to radio frequency identification transponder memory.

### BACKGROUND

A radio frequency identification (RFID) transponder is a small module that is suitable for contactless read/write applications. RFID transponders may be attached to or incorporated into objects and, for example, the RFID transponders may be used to identify the objects. In general, RFID transponders include integrated circuits to enable the RFID transponders to receive and to respond to radio frequency (RF) signals transmitted by an RFID interrogator. For example, as soon as an RFID transponder is exposed to an RF signal, the RFID transponder responds by continuously transmitting stored data.

Typically, a memory that may be used in RFID transponders is a Read-Only Memory (ROM) (e.g., Electrically-Erasable Programmable Read-Only Memory (EEPROM)). Another memory that may be used in RFID transponders is a group of registers. Such ROMs and registers may lack the ability to be used for different applications and for customization. For example, some ROMs and registers are fixed and therefore require a new mask layout and fabrication with new or different values. With EEPROMs, a large amount of current (or voltage) is required to access the EEPROMs. As a result, RFID transponders typically include a large charge pump configured to increase the voltage used for program operations. A large charge pump equates to a large RFID transponder. Further, programming an EEPROM can take a long period of time relative to the time an RFID transponder is exposed to the RF signal. A programming error may occur if the time to program the EEPROM is longer than the time the RFID transponder is exposed to the RF signal.

There are continuing efforts to improve memories associated with RFID transponders.

### BRIEF DESCRIPTION OF THE DRAWINGS

The present invention will be readily understood by the following detailed description in conjunction with the accompanying drawings, and like reference numerals designate like structural elements. Although the Drawings depict various examples of the invention, the invention is not limited by the depicted examples. Furthermore, the depictions are not necessarily to scale:

FIG. 1 is a diagram of a radio frequency identification (RFID) communication system, in accordance with an embodiment;

FIG. 2 is a simplified block diagram of a general overview of an RFID transponder, in accordance with an embodiment;

FIG. 3 is a simplified block diagram of an exemplary RFID transponder, in accordance with an embodiment;

FIG. 4 is a simplified block diagram of a vertically configured non-volatile memory array, in accordance with an embodiment;

FIG. 5 is a simplified block diagram of a cross section of a vertically configured RFID transponder, in accordance with an embodiment;

FIG. 6 is a detailed block diagram of an exemplary RFID transponder, in accordance with an embodiment; and

FIG. 7 is a detailed block diagram of another exemplary RFID transponder, in accordance with an embodiment.

### DETAILED DESCRIPTION

A detailed description of one or more embodiments is provided below along with accompanying figures. The detailed description is provided in connection with such embodiments, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

The embodiments described herein provide memories for radio frequency identification (RFID) transponders. In some embodiments, the RFID transponder includes a vertically configured non-volatile memory array. The vertically configured non-volatile memory array is configured to store data. The RFID transponder may read data from and write data to the non-volatile memory array. As will be explained in more detail below, in some embodiments, the vertically configured non-volatile memory array may be disposed above the logic circuitries associated with the RFID transponder.

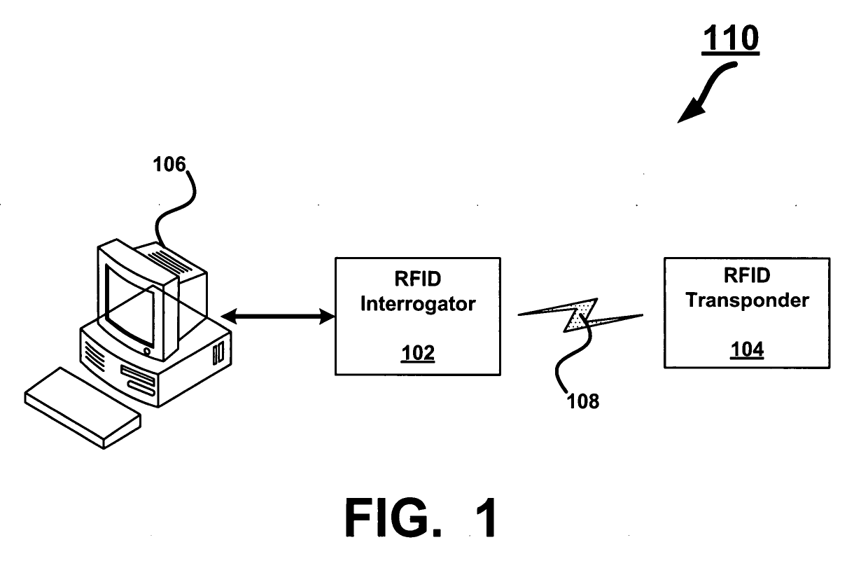

FIG. 1 is a diagram of an RFID communication system, in accordance with an embodiment. As shown in FIG. 1, RFID communication system 110 includes RFID transponder 104, RFID interrogator 102, and computing device 106. RFID interrogator 102 may be a microcontroller-based device with peak detector hardware, firmware, comparators, and other components configured to transmit radio frequency (RF) signal 108 to RFID transponder 104 and read data back from the RFID transponder 104. Computing device 106 connected with RFID interrogator 102 may be configured to process the data read from RFID transponder 104 and/or provide data to the RFID interrogator 102 for transmission to the RFID transponder 104. Here, RFID transponder 104 is configured to receive and respond to RF signal queries transmitted from RFID interrogator 102.

To interrogate RFID transponder 104, RFID interrogator 102 transmits RF signal 108 to the RFID transponder 104. RF signal 108 may be an RF sine wave with, for example, frequencies of 124 kHz, 13 MHz, 13.56 MHz, 868 MHz, 915 MHz, or other frequency ranges. When RFID transponder 104 is exposed to RF signal 108, the RFID transponder 104 may be configured to collect power from the RF signal 108. For instance, an antenna (not shown) included in RFID transponder 104 uses RF signal 108 to generate an electrical current to power the RFID transponder 104. The electrical current induced in the antenna by RF signal 108 can provide the power for the integrated circuit in RFID transponder 104 to power up and, for example, transmit a response to RFID interrogator 102. It should be noted that RFID transponder 104 also may include a power supply (e.g., a battery) to power the RFID transponder 104.

With RFID transponder 104 powered by RF signal 108 or an internal power supply, the RFID transponder 104 can read data from a memory (e.g., a vertically configured non-volatile memory array) and transmit the data to RFID interrogator 102. In another example, RFID transponder 104 may also respond to RFID signal 108 by writing data encoded in the RF signal 108 to a memory included in the RFID transponder 104. Here, RFID interrogator 102 transmits data encoded in RF signal 108 and, when exposed to the RF signal 108, RFID transponder 104 writes the data to the memory.

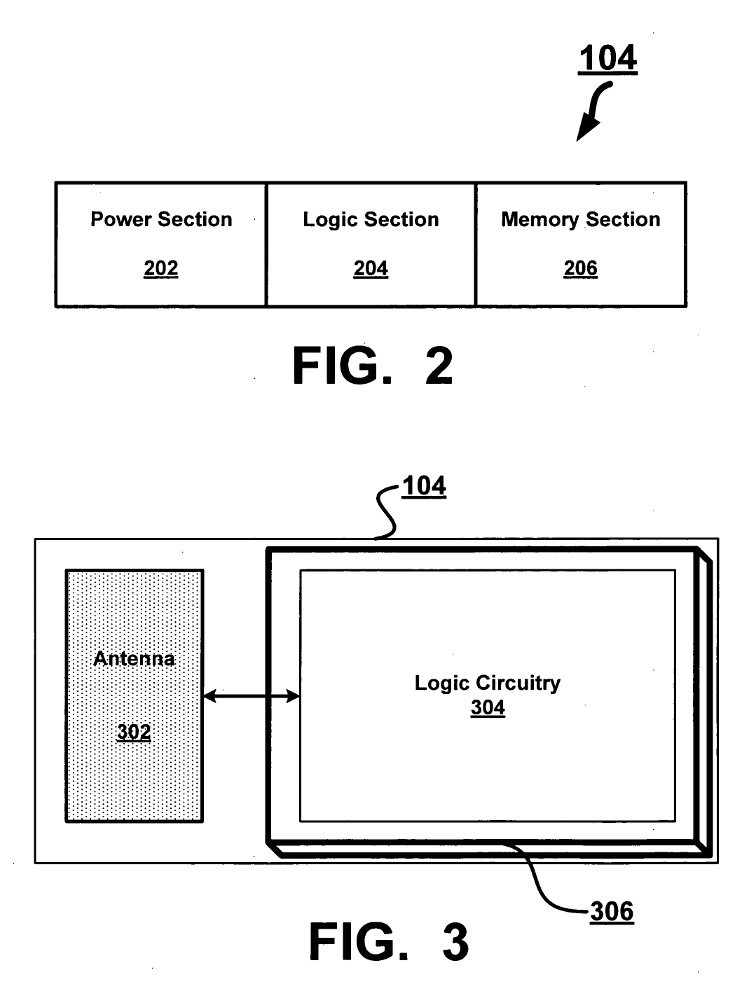

FIG. 2 is a simplified block diagram of a general overview of an RFID transponder, in accordance with an embodiment. In general, RFID transponder 104 may include an antenna, modulation circuitry, and vertically configured non-volatile memory. RFID transponder 104 may be divided into different sections. For example, as shown in FIG. 2, RFID transponder 104 may be divided into a power section 202, a logic section 204, and a memory section 206. Generally, as will be explained in more detail below, power section 202 may include the antenna, the modulator, power-on reset, charge pump (e.g., voltage multiplier), power supply (e.g., a battery), and other components. Logic section 204 may include modulation logic, clock generator, memory controller, timer, and other components. Memory section 206 may include address driver, data driver, vertically configured non-volatile memory array that may be disposed above power section 202 and/or logic section 204, vertically configured non-volatile memory logic, and other components.

FIG. 3 is a simplified block diagram of an exemplary RFID transponder, in accordance with an embodiment. In general, as shown in FIG. 3, RFID transponder 104 includes antenna 302, logic circuitry 304, and vertically configured non-volatile memory array 306. Antenna 302 may be configured to collect power from an RF signal for RFID transponders, such as RFID transponder 104, without an internal power supply. When an RF signal passes through a coil of antenna 302, an alternating current voltage is generated across the antenna. The voltage may be rectified to supply power to RFID transponder 104. Furthermore, it should be appreciated that RFID transponder 104 may signal or transmit data by backscattering the RF signal from an RFID interrogator. Thus, antenna 302 may be configured to collect power from the RF signal and also to transmit the outbound backscatter RF signal (e.g., data).

Here, logic circuitry 304 is connected with antenna 302 and the vertically configured non-volatile memory array 306, and the logic circuitry 304 may be configured to read data from or write data to the vertically configured non-volatile memory array 306. For example, as will be explained in more detail below, logic circuitry 304 may include a memory controller to control read and write memory access, error detection, error handling, and other operations. Logic circuitry 304 may additionally include a modulator to modulate or encode the data read from vertically configured non-volatile memory array 306. A charge pump may also be included in logic circuitry 304 to increase the voltage of the power collected from the RF signal for data operations to the vertically configured non-volatile memory array 306, such as read operations and program (or write) operations.

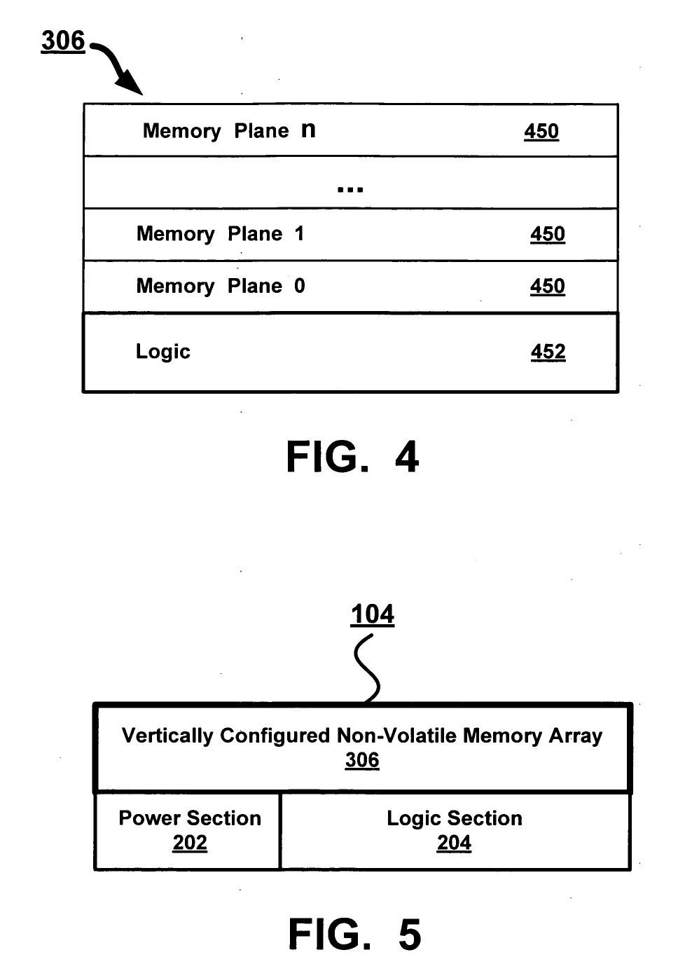

Vertically configured non-volatile memory array 306, which is connected to logic circuitry 304 and may be disposed above logic circuitry 304, can include a memory array that can be vertically configured along multiple memory planes. For example, memory planes can be implemented that emulate various types of memory technologies that permit different physical and logical arrangements (e.g., vertically stacked). In general, vertically configured non-volatile memory array 306 may be a two-terminal cross-point array where, as shown in the exemplary embodiment of FIG. 4, memory arrays in the form of memory planes 450 may be stacked on top of logic 452. Logic 452 may be formed in a substrate, such as a semiconductor, for example. As one example, the logic 452 can be formed in a silicon (Si) wafer. Other active circuitry can be included in the substrate in addition to the logic 452 (e.g., a power section, a memory controller, etc.). In FIG. 4, vertically configured non-volatile memory array 306 allows for multiple memory planes 450 to be stacked upon one another and data may be read from and written to the memory planes, which may be further divided into memory sub-planes. Furthermore, vertically configured non-volatile memory array 306 allows changes to memory bits at random (i.e., random access) and allows for fast and low voltage program operations. By way of example, vertically configured non-volatile memory array 306 can program in less than about 100 nanoseconds using about ±3 volts. As used herein, the term “about” means that the specified dimension or parameter may be varied within an acceptable tolerance for a given application. For example, an acceptable manufacturing tolerance is ±10%. U.S. patent application Ser. No. 11/095,026, filed Mar. 30, 2005, and titled “Memory Using Mixed Valence Conductive Oxides,” hereby incorporated by reference in its entirety and for all purposes, describes two-terminal memory cells that can be arranged in a cross-point array. The application describes a two-terminal memory element that changes conductivity when exposed to an appropriate voltage drop across the two terminals. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (such as selection circuitry).

The two-terminal memory elements can be arranged in a cross-point array such that one terminal is electrically coupled with an x-direction line and the other terminal is electrically coupled with a y-direction line. A stacked cross-point array consists of multiple cross-point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½−V_{W1} to the y-direction line) it switches to a low resistive state. When a second write voltage V_{W2} is applied across the memory element, (typically by applying ½ V_{W2} to the x-direction line and ½−V_{W2} to the y-direction line) it switches to a high resistive state. Typically, memory elements using electrolytic tunnel barriers and mixed valence conductive oxides require V_{W1} to be opposite in polarity from V_{W2}.

FIG. 5 is a simplified block diagram of a cross section of a vertically configured RFID transponder, in accordance with an embodiment. As discussed above, vertically configured non-volatile memory array 306 can include a memory array that can be vertically configured along multiple memory planes. Accordingly, as shown in FIG. 5, vertically configured non-volatile memory array 306 may be disposed above logic section 204 and power section 202. In other words, vertically configured non-volatile memory array 306 may be stacked on top of power section 202 and logic section 204. By disposing vertically configured non-volatile memory array 306 above power section 202 and logic section 204, the vertically configured non-volatile memory array 306 can extend across a surface of RFID transponder 104. As a result, RFID transponder 104 can have a larger vertically configured non-volatile memory array 306 or the die size of RFID transponder 104 can be made smaller with the same memory capacity.

Furthermore, in some embodiments, vertically configured non-volatile memory array 306 allows for multiple vertically configured non-volatile memory arrays, such as vertically configured non-volatile memory array 306, to be disposed above one another. Accordingly, RFID transponder 104 may have multiple, vertically configured non-volatile memory arrays disposed above power section 202 and logic section 204.

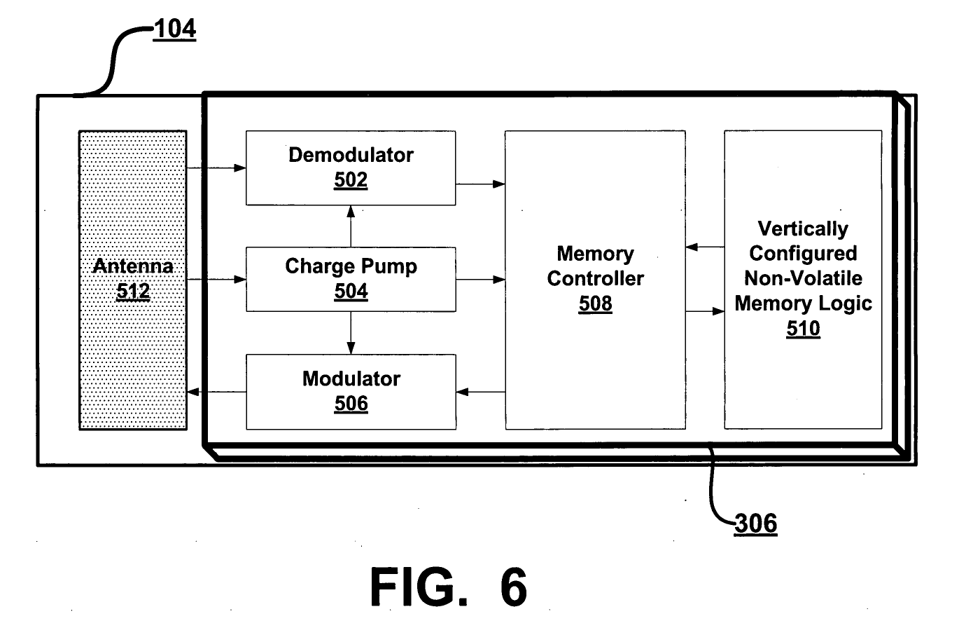

FIG. 6 is a detailed block diagram of an exemplary RFID transponder 104, in accordance with an embodiment. As shown in FIG. 6, RFID transponder 104 includes antenna 512, demodulator 502, charge pump 504, modulator 506, memory controller 508, vertically configured non-volatile memory logic 510, and vertically configured non-volatile memory array 306. Here, vertically configured non-volatile memory array 306 may be disposed above logic demodulator 502, charge pump 504, modulator 506, memory controller 508, and vertically configured non-volatile memory logic 510. As a result, vertically configured non-volatile memory array 306 can thus extend across a surface of RFID transponder 104. It should be appreciated that vertically configured non-volatile memory array 306 may extend across various surface portions of RFID transponder 104. For example, vertically configured non-volatile memory array 306 may extend across the entire surface of RFID transponder 104. Accordingly, vertically configured non-volatile memory array 306 may be disposed above logic demodulator 502, charge pump 504, modulator 506, memory controller 508, vertically configured non-volatile memory logic 510, and antenna 512. In another example, vertically configured non-volatile memory array 306 may extend across and disposed above the portion occupied by memory controller 508 and vertically configured non-volatile memory logic 510.

With the RFID transponder 104 shown in FIG. 6, antenna 512 receives an RF signal and charge pump 504 converts a portion of the RF signal to direct current (DC) voltage to power RFID transponder 104. Charge pump 504 may include a capacitor configured to store energy for supply to RFID transponder 104 during gaps in the received RF signal. Additionally, charge pump 504 may also increase the DC voltage used for programming data to (or writing data to) and erasing data from vertically configured non-volatile memory array 306.

By way of memory controller 508 and vertically configured non-volatile memory logic 510, data can be written to or read from vertically configured non-volatile memory array 306. In addition to controlling read and write memory accesses, memory controller 508 also may be configured to handle protocols, conduct cyclic redundancy checks, handle anti-collision features, handle error detection, enable or disable circuits, and other operations. Vertically configured non-volatile memory logic 510 includes logic associated with vertically configured non-volatile memory array 306. For example, vertically configured non-volatile memory logic 510 may include address drivers, data buffers, address decoders, control logic, and other logic.

In general, demodulator 502 can convert an input signal (e.g., pulse-width modulated input signal) to digital data and can generate a synchronous system clock. It should be appreciated that RFID transponder 104 may transmit data to an RFID interrogator by using backscatter (reflective load) modulation. Generally, backscatter is the reflection of RF signals back to the RFID interrogator. Modulator 506 can convert data received from memory controller 508 to changes in the input impedance. For example, modulator 506 can change or cause variations in the input impedance of RFID transponder 104 such that the RF signal scattered or reflected back to RFID interrogator is modulated. The amplitude-modulation loading of the RF signal provides a communication path back to an RFID interrogator. Modulator 506 can modulate data with a variety of data modulation or encoding techniques. An exemplary data modulation technique is direct modulation where a high in the envelope corresponds to a one bit and a low in the envelope corresponds to a zero bit. Another exemplary data modulation technique is Frequency Shift Keying (FSK) that uses two different frequencies for data transfer. An exemplary FSK technique is transmitting a zero bit as an amplitude-modulated clock cycle with the period corresponding to the carrier frequency divided by eight, and transmitting a one bit as an amplitude-modulated clock cycle period corresponding to the carrier frequency divided by ten. Another exemplary modulation technique is Differential Biphase where the bitstream that is clocked out is modified such that a transition occurs on every clock edge, and one bit and zero bit are distinguished by the transitions within the middle of the clock period. Other exemplary data modulation techniques include Non-Return to Zero Direct, Biphase_L, and Phase Shift Keying.

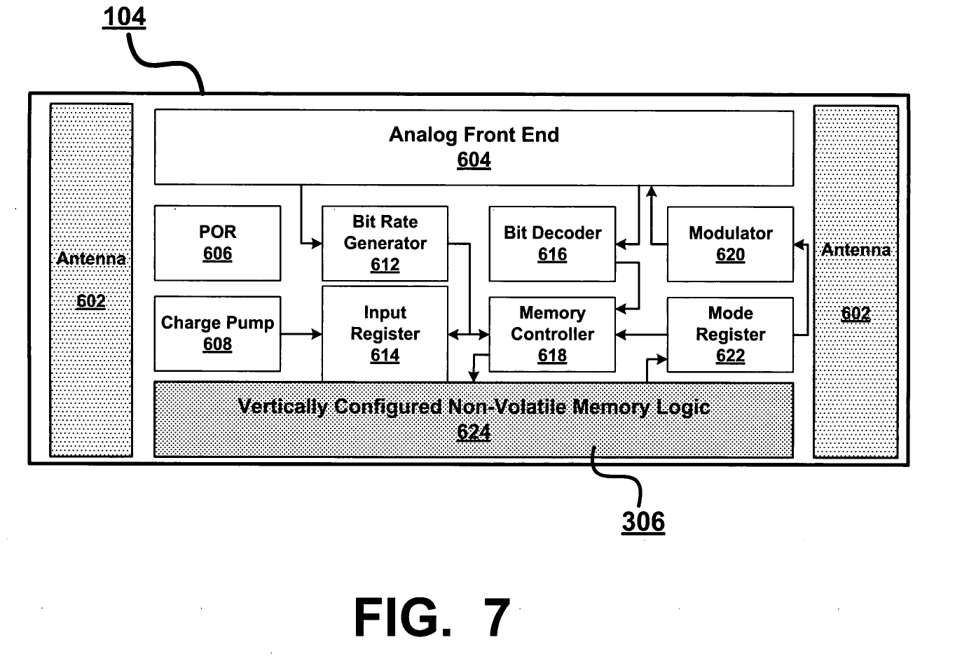

FIG. 7 is a detailed block diagram of another exemplary RFID transponder, in accordance with an embodiment. As shown in FIG. 7, RFID transponder 104 includes antennas 602, analog front end 604, power-on reset (POR) 606, charge pump 608, bit rate generator 612, input register 614, bit decoder 616, memory controller 618, modulator 620, mode register 622, vertically configured non-volatile memory logic 624, and vertically configured non-volatile memory array 306. Here, vertically configured non-volatile memory array 306 may be disposed above analog front end 604, POR 606, bit rate generator 612, bit decoder 616, modulator 620, charge pump 608, input register 614, memory controller 618, mode register 622, and vertically configured non-volatile memory logic 624. As discussed above, vertically configured non-volatile memory array 306 can thus extend across a surface of RFID transponder 104.

Analog front end 604 includes circuits that are connected to antennas 602 and generates the power supply and handles data communication with an RFID interrogator. Analog front end 604 may include a rectifier to generate a DC voltage from an AC coil voltage, a clock extraction circuit configured to generate an internal clock source from the RF signal, field gap detector for data transmission from RFID interrogator, electrostatic discharge (ESD) protection, and other circuitries.

Exposure of RFID transponder 104 to an RF signal triggers a power-on reset pulse. Power-on reset 606 delays functionality of RFID transponder 104 until an acceptable voltage threshold has been reached. Charge pump 608 increases the voltage for writing data to or erasing data from vertically configured non-volatile memory array 306. Bit rate generator 612 selects the data transmission rate to different frequencies (e.g., 7.81 kHz or 3.91 kHz). Bit decoder 616 decodes and verifies the RF signal. As discussed above, modulator 620 modulates or encodes the data shifted out from vertically configured non-volatile memory array 306. Mode register 622 is configured to hold the configuration data bits stored in vertically configured non-volatile memory array 306. Input register 614 is configured to hold data bits for programming or writing into vertically configured non-volatile memory array 306. Memory controller 618 and vertically configured non-volatile memory logic 624 controls read and write access of vertically configured non-volatile memory array 306. Additionally, memory controller 618 may handle data transmission, handle data decoding, detect errors, handle errors, refresh mode register 622 at start of read operation, and handle other operations.

The above-described embodiments provide an RFID transponder with one or more vertically configured non-volatile memory arrays. The RFID transponder may include a vertically configured non-volatile memory array that is disposed above logic circuitries associated with the RFID transponder. By disposing the vertically configured non-volatile memory array above the logic circuitries, the RFID transponder can have a vertically configured non-volatile memory array that extends across a surface of the RFID transponder, thereby allowing for more memory capacity. The die size of RFID transponder also can be made smaller with the same memory capacity. The placement of the vertically configured non-volatile memory array also provides more space for the logic circuitries and thus, allows more functionality for a fixed die size. Exemplary functions that may be added include monitoring conditions or events such as temperatures and security conditions.

Furthermore, vertically configured non-volatile memory array uses low voltage for program operations. The reduced voltage thereby allows for small charge pumps or other circuitries associated with the power section. Program operations with a vertically configured non-volatile memory array also take a short period of time (in nanoseconds). Thus, the amount of time the RFID transponder is exposed to the RF signal may be reduced, thereby resulting in more reliable memory access operations.

Although the foregoing embodiments have been described in some detail for purposes of clarity of understanding, the embodiments are not limited to the details provided. There are many alternative ways of implementing the embodiments. Accordingly, the disclosed embodiments are to be considered as illustrative and not restrictive, and the embodiments are not to be limited to the details given herein, but may be modified within the scope and equivalents of the appended claims. In the claims, elements and/or operations do not imply any particular order of operation, unless explicitly stated in the claims.

What is claimed is:

1. A radio frequency identification transponder, comprising:
a vertically configured non-volatile memory array;
a logic circuitry connected with the vertically configured non-volatile memory array, the logic circuitry being configured to read a first data from the vertically configured non-volatile memory array; and
an antenna connected with the logic circuitry, the antenna being configured to generate power from a radio frequency signal and to transmit the first data.

2. The radio frequency identification transponder of claim 1, wherein the vertically configured non-volatile memory array is disposed above the logic circuitry.

3. The radio frequency identification transponder of claim 1, wherein the logic circuitry includes a memory controller.

4. The radio frequency identification transponder of claim 1, wherein the logic circuitry includes a modulator configured to encode the first data read from the vertically configured non-volatile memory array.

5. The radio frequency identification transponder of claim 1, wherein the logic circuitry includes a charge pump configured to increase a voltage associated with the power from the radio frequency signal.

6. The radio frequency identification transponder of claim 1, wherein the vertically configured non-volatile memory array comprises two-terminal memory cells.

7. The radio frequency identification transponder of claim 1, wherein a second data is encoded in the radio frequency signal, wherein the antenna is configured to receive the radio frequency signal, and wherein the logic circuitry is configured to write the second data to the vertically configured non-volatile memory array.

8. A radio frequency identification transponder, comprising:
a vertically configured non-volatile memory array;
a memory controller connected with the vertically configured non-volatile memory array, the memory controller being configured to read data from the vertically configured non-volatile memory array;
a power supply connected with the memory controller; and
an antenna connected with the memory controller, the antenna being configured to transmit the data.

9. The radio frequency identification transponder of claim 8, wherein the vertically configured non-volatile memory array is disposed above the memory controller.

10. The radio frequency identification transponder of claim 8 and further comprising:
a modulator connected with the memory controller, the modulator being configured to encode the data read from the vertically configured non-volatile memory array.

11. The radio frequency identification transponder of claim 8, wherein the memory controller is configured to access the vertically configured non-volatile memory array randomly.

12. The radio frequency identification transponder of claim 8, wherein the vertically configured non-volatile memory array comprises two-terminal memory cells.

13. A radio frequency identification communication system, comprising:
a radio frequency identification transponder comprising a vertically configured non-volatile memory array; and
a radio frequency identification interrogator configured to transmit a radio frequency signal to the radio frequency identification transponder.

14. The system of claim 13, wherein the radio frequency identification transponder is configured to read data from the vertically configured non-volatile memory array and to transmit the data to the radio frequency identification interrogator.

15. The system of claim 13, wherein the radio frequency identification interrogator is configured to transmit data encoded in the radio frequency signal to the radio frequency identification transponder and the radio frequency identification transponder is configured to write the data to the vertically configured non-volatile memory array.

16. The system of claim 13, wherein the radio frequency identification transponder further comprises,
a logic circuitry connected with the vertically configured non-volatile memory array, the logic circuitry being configured to read data from the vertically configured non-volatile memory array, and
an antenna connected with the logic circuitry, the antenna being configured to generate power from the radio frequency signal and to transmit the data.

17. The system of claim 16, wherein the vertically configured non-volatile memory array is disposed above the logic circuitry.

18. The system of claim 16, wherein the vertically configured non-volatile memory array is configured as a cross-point array.

19. The system of Claim. 16, wherein the vertically configured non-volatile memory array comprises a plurality of two-terminal memory cells.

20. The system of claim 19, wherein each two-terminal memory cell stores data as a plurality of conductivity profiles that can be non-destructively sensed by applying a read voltage across the terminals of two-terminal memory cell, the two-terminal memory cell retains stored data in the absence of power, and new data can be written to the two-terminal memory cell by applying a write voltage across the terminals of two-terminal memory cell.
